(19) United States
(12) Patent Application Publication
(10) Pub. No.: US 2019/0210425 A1
(43) Pub. Date: Jul. 11, 2019

(54) COOLANT CIRCULATION LOOP FOR VEHICLE

(71) Applicant: Valeo Systemes Thermiques, Le Mesnil Saint Denis (FR)

(72) Inventors: Kamel Azzouz, Le Mesnil Saint Denis (FR); Bastien Jovet, Le Mesnil Saint-Denis (FR)

(73) Assignee: Valeo Systemes Thermiques, Le Mesnil Saint Denis (FR)

(21) Appl. No.: 16/311,735

(22) PCT Filed: Jun. 16, 2017
(86) PCT No.: PCT/FR2017/051587

§ 371 Date: Dec. 20, 2018

(30) Foreign Application Priority Data
Jun. 21, 2016 (FR) 1655770

(51) Int. Cl. B60H 1/00; B60H 1/32

(52) U.S. Cl. CPC B60H 1/00492; B60H 1/00328; B60H 1/00342; B60H 1/00385; B60H 1/00485; B60H 2001/3261; B60H 1/00921; B60H 1/3213; B60H 2001/00928; B60H 2001/3258; B60H 2001/326; B60H 1/00914

(57) ABSTRACT

The invention relates to a coolant circulation loop (100) for a motor vehicle comprising a heat-exchange device (120) comprising at least an evaporator (121) and a distribution element (155) controlled to configure the loop in at least a first mode in which the coolant does not pass through the evaporator and a second mode in which the coolant passes through the evaporator.

According to the invention, the loop further comprises at least one thermal energy storage module (160) comprising a material capable of changing phase (163), the storage module being arranged on the passage of the fluid whether the loop is configured according to the first or the second mode.

The present application relates to a coolant circulation loop, applied to a heating, ventilation and/or air conditioning installation for a motor vehicle, and more particularly for electric cars or hybrid cars.

An electric or hybrid car comprises a heating, ventilation, air conditioning and/or reversible air conditioning loop, also called heat pump, in order to vary the temperature inside its interior, and in particular to heat it up in wintery periods and, thus, provide a certain comfort for the user thereof.

More specifically, the temperature of the interior can be moderated by the circulation of a coolant between a heat-exchange device arranged in the vehicle, generally in the vicinity of the interior, and a air heater situated in contact with the ambient air, at the front face of the vehicle. A circulation loop can thus be formed in the vehicle to supply to one and to the other of the heat-exchange means the coolant in an appropriate state.

The coolant absorbs or gives off heat at the air heaters depending on the phases of operation of the heat pump. A compressor can be used to compress the coolant in the heating loop and thus change the temperature of the coolant required to subsequently pass through different heat-exchange means.

The compressor, just like any electrical member, is powered by the batteries of the vehicle. The life of the batteries therefore depends directly on the speed of operation of the compressor. Now, the more the temperature drops outside the interior, the more the speed of the compressor has to increase in order to ensure the same comfort for the user of the vehicle. Because of this, in winter conditions, the heating loop consumes much more energy, commensurate with the electrical range of the vehicle.

Moreover, the air heater situated at the front face of the vehicle, generally under the hood, called front-end air heater, operates in particular by means of the outside air passing through it. Now, because of its direct exposure to the outside air without the latter being able to be heated up by the structure of the vehicle before its passage into the front-end air heater, is likely to freeze when the outside temperature is very low, for example lower than 2 or 3° C. The coolant, colder than the ambient air, causes a condensation on the wails of the air heater and ice is possible in conditions of low temperature and high relative humidity.

The present invention thus aims to remedy this drawback, by proposing a coolant circulation loop of heating, ventilation and/or air conditioning type, which is more economical in terms of electrical consumption, particularly in winter conditions of use and which makes it possible to avoid the full-load operation of the front-end air heater without in any way penalizing the efficiency of the heating, ventilation and/or air conditioning installation, that is to say by increasing the heating power at very low temperature, particularly the temperatures lower than −10° C.

In this context, the present invention proposes a coolant circulation loop for a motor vehicle comprising a heat-exchange device comprising at least an evaporator and a distribution element controlled to configure the loop according to at least a first mode in which the coolant does not pass through the evaporator and a second mode in which the coolant passes through the evaporator.

The distribution element thus makes it possible to switch from a first, heat pump mode, in which the interior of the vehicle is heated up, to a second, air-conditioning mode, in which the interior is cooled.

According to the invention, the circulation loop further comprises at least one thermal energy storage module comprising a material capable of changing phase, the storage module being arranged on the loop whatever the configuration given by the distribution element, that is to say whether the loop is configured equally according to the first mode or the second mode.

It is noteworthy that the storage module is arranged on the loop of the heat pump, that is to say that it is operational whatever the mode configured, heat pump or air conditioning, since it can supply the necessary energy to the coolant.

The storage module makes it possible to exchange thermal energy with the coolant, which advantageously makes it possible to raise the temperature of the fluid circulating in the circulation loop given that the phase change material arranged in the storage module is in a state suitable for transmitting energy to the coolant. In this way, in the circulation loop, particularly in its passage in the heat-exchange device, the coolant has a high temperature without the work of the compressor to pressurize said fluid to a desired value being too energy-consuming. This makes it possible to significantly reduce the electrical consumption of the heating, ventilation and/or air conditioning installation. It is understood that this invention is particularly advantageous when the vehicle operates using an electric battery, the range of the vehicle and the life of the battery being increased thereby.

According to a preferred embodiment of the invention, the loop comprises a front-end air heater and the thermal energy storage module is arranged in parallel with the front-end air heater in the circulation loop. The temperature rise of the fluid is different from that that it would have had by passing through the air heater, such that a phase of pre-conditioning of the vehicle is created in which the energy previously stored in the storage means is drawn to heat up the coolant and keep it in conditions suitable for heating up the air required to pass through the heat-exchange device to be blown into the interior.

A front-end air heater is understood to be a air heater intended to be present outside the interior of the vehicle, preferentially at the front face of the vehicle, directly in contact with the air outside the vehicle.

Furthermore, on starting the vehicle, particularly in very cold conditions, when the storage module is recharged, the coolant is required to pass through the storage module rather than through the front-end air heater and a condensation is thus avoided on the walls of the front-end air heater which can create an icing thereof.

The thermal storage module can in particular comprise a casing produced in a heat-conducting material, preferably metal, comprising a hollow internal chamber, containing the phase change material, and an inlet and an outlet via which, respectively, the coolant is introduced into the casing and escapes from the casing, such that at least a part of the coolant flowing in the casing interacts thermally with the phase change material. In this way, a heat exchange between the coolant and the phase change material takes place within the hollow chamber formed by the casing.

The phase change materials placed in the hollow chamber can for example be in the form of multiple tubes, microbeads or granules, along which the coolant can flow by passing through the casing from the inlet to the outlet. During this flow, at least a part of the coolant is then induced to exchange heat with the phase change material. Obviously, other configurations allowing a thermal interaction between the phase change material and the coolant flowing through the casing can be envisaged.

Typically, according to one possible embodiment, a duct links the inlet to the outlet of the casing, the hollow internal chamber of the casing then preferentially sharing at least one common wall with the duct such that the heat of the fluid, respectively of the phase change material, is transferred via this wall to the phase change material, respectively to the fluid. It will in particular be possible to provide for the heat-conducting material forming the casing receiving the phase change material to be aluminum.

It is particularly possible to provide for the casing receiving the phase change material to have a cylindrical form of annular, rectangular or other form of section suitable for conducting the coolant and containing the phase change material, the phase change material being, for example, arranged all around the coolant circulation duct at the center of the casing. It will also be possible to provide a thermal insulation device around the thermal energy storage means.

According to a series of features, taken alone or in combination, specific to the phase change material used advantageously in the present circulation loop, it would be possible to provide for:

the phase change material to be able to comprise a material comprising inorganic compounds such as an alloy of organic salts and of water;

the phase change material to be able to comprise a material comprising organic compounds such as paraffins and fatty acids;

the phase change material to be able to comprise a material comprising eutectic compounds;

the phase change material to be able to comprise a material comprising compounds of plant origin;

the phase change material to be incorporated in the storage module in liquid form;

the phase change material to be incorporated in the storage module in the form of a polymerized composite material, in particular in sheet form;

the phase-change temperature of said phase change material to lie between 10° C. and 40° C;

the critical phase-change temperature of the phase change material to be 15° C.

Preferably, the storage module can store at least 200 Wh, preferably at least 400 Wh, in order for the storage module to be able to heat the calorific fluid for long enough to optimally preserve the electrical consumption of the battery of an electric car, at least at the start of a journey of the vehicle (typically for approximately 20 minutes), and do so whatever the outside temperature.

As has been specified previously, the thermal energy storage module can be linked in parallel to the front-end air heater. It will be particularly possible to produce this parallel connection of the thermal storage module via at least one valve driven to control the flow rate of coolant passing through the storage module.

With the circulation loop there is associated a control unit making it possible to modify the position of at least one valve, particularly when starting the compressor, such that at least a part, preferably all, of the coolant exchanges thermal energy with the storage module. The control unit can thus isolate the front-end air heater from the circulation loop, such that the coolant circulates through the storage module rather than through the front-end air heater. That is particularly advantageous when the temperature of the ambient air is lower than the temperature of the storage module. Such is the case for example when the circulation loop is used in winter.

According to a feature of the invention, a first thermal probe is provided, intended to measure the temperature of the air outside the interior of the vehicle. This first probe can in particular be linked to the control module described above for the latter to assess the relevance or not of having the calorific fluid pass into the thermal storage module in parallel with the air heater, that is to say, in other words, to limit the phenomenon of losses of heat of the calorific fluid at this front-end air heater.

It will also be possible to provide means for measuring a determined time period, particularly in order to control the position of at least one valve as a function of this determined time period. This makes it possible in particular to control the passage of the coolant through the thermal storage module for a defined period, in order to not completely drain the thermal energy from the storage module and to make only occasional use thereof.

Furthermore, a control unit as presented above will be able to comprise means for storing a circulation loop control program, and at least one temperature threshold value, and/or at least one time reference value. An example of control program is described below. A temperature threshold value corresponds to a temperature at which it is more advantageous to have the coolant pass through the storage module than through the front-end air heater. The terms “more advantageous” are understood here to mean the fact of being able to reduce the electrical consumption of the compressor and/or limit the risk of the formation of ice on the front-end air heater. According to an advantageous embodiment, the temperature threshold value is determined as a function of at least one measured value of the temperature outside the vehicle and/or the temperature of the phase change material and/or the temperature of the coolant. Typically, the temperature threshold value can be configured as being equal to the temperature outside the vehicle (measured by the first probe), or as being equal to a temperature of +/−1° C. to +/−10° C. relative to the outside temperature. Thus when the temperature threshold value is not reached at the third probe (that is to say at the phase change material), the coolant originating from the heat-exchange device can be directed to the storage module, whereas, when the measured value is equal to or above the threshold value, the flow rate of the coolant originating from the heat-exchange device is directed to the front-end air heater. As a purely illustrative example, a temperature threshold value can lie between −20° C. and 5° C., preferably be of the order of −10° C. Obviously, these values can also be adapted, for example according to the configuration of the circulation loop and of the component elements thereof. Likewise, a time reference value can depend on the same criteria as those mentioned above.

According to one embodiment of the invention, the heat-exchange device comprises an evaporator and an internal condenser that are distinct, supplied respectively with air and not according to the position of a mixing flap, and nozzles distributing the air passed through the evaporator, or through the condenser, into the interior of the vehicle. The heat-exchange device can then take the form of an HVAC (acronym for “Heating, Ventilation and Air-Conditioning”) unit.

In an alternative embodiment, provision can be made to form the circulation loop to adapt it to an HVAC unit in which the condenser is replaced by a radiator, in particular by incorporating a second fluid in an additional. circuit arranged between the heat-exchange device and an air-water cooling exchanger mounted on the circulation loop downstream of the compressor. A second stage is thus formed with a water condenser and a pump added on the additional circuit, particularly to adapt to existing vehicle structures including radiators. It will thus be possible to use, for electric or hybrid vehicles, heat-exchange devices used elsewhere by internal combustion engine vehicles.

In each of these cases, it will be possible to provide the presence of a second thermal probe intended to measure the temperature of the air inside the interior of the vehicle and/or of the coolant at the outlet of the air distribution element, in order in particular to determine whether the coolant has to pass through the thermal storage element, more particularly in the case of the recharging of the electric vehicle and of the possibility of replenishing the thermal energy used previously in the thermal storage module. As a variant or in addition, the control unit can also be connected to a third thermal probe intended to measure the temperature of the phase change material in the storage module. It is understood that if a coolant, raised to a temperature above the phase-change temperature of the material housed in the storage module, circulates in the storage module, the material is likely to change phase and thus store up energy.

The invention relates also to a vehicle comprising a circulation loop described above.

The invention relates also to a method for controlling the circulation of a coolant in a thermal loop described above, comprising at least a step of measuring the temperature of the ambient air and/or of the coolant circulating in the loop and/or of the phase change material, and a step of comparison of this measured value with a temperature threshold value, and a control step aiming to direct the coolant wholly or partly through the thermal storage module depending on the result of the comparison step.

In particular, it will be possible to provide for, when the measured temperature value of the ambient air is lower than the threshold value, at least a part, preferably all, of the flow rate of the coolant originating from the heat-exchange device to pass through the storage module, whereas, when the measured value is equal to or above the threshold value, at least a part, preferably all, of the flow rate of the coolant originating from the heat-exchange device to pass through the front-end air heater.

The control method according to the invention thus makes it possible to use or preserve the heat of the storage module, according to the temperature of the air located outside the interior of the vehicle. When the ambient air is, by way of example, lower than −10° C., it is estimated, on the one hand, that the passage of cold air into the evaporator-condenser presents a risk of icing the condensation formed on the walls of this evaporator-condenser and, on the other hand, that the effort to be provided by the compressor to bring the coolant to the appropriate pressure to pass through the heat-exchange device is too great, and the coolant is then made to pass through the thermal storage module, the phase change material participating in the increasing of the energy of the fluid to an extent that is most appropriate to the economical operation of the loop.

The control method can provide for a time-related notion to be introduced for the passage of at least a part, preferably all, of the flow rate of the coolant originating from the heat-exchange device. Thus, the coolant can exchange the heat with the storage module for a period determined on starting the compressor, before passing through the front-end air heater. This solution is particularly suitable for daily use of the air-conditioning loop in winter conditions when the temperature is often below 0° C.

It will also be possible to provide for the control method to take account of the temperature of the coolant, such that, when the measured value is above the threshold value, at least a part, preferably all, of the flow rate of the coolant originating from the heat--exchange device passes through the storage module and such that, when the measured value is equal to or lower than the threshold value, at least a part, preferably all, of the flow rate of the coolant originating from the heat-exchange device passes through the front-end air heater. According to this alternative, it is thus possible to use a part of the heat of the coolant to heat the thermal energy storage module and to recharge the storage module, whether this is while the vehicle is running when the heating of the interior is stopped, or even when it is being recharged on electric terminals.

Obviously, the features, the variants and the different embodiments of the invention can be associated with one another, according to various combinations, inasmuch as they are not mutually incompatible or exclusive.

The features of the invention mentioned above, and others, will become more clearly apparent on reading the detailed description of nonlimiting examples below, with reference to the following attached drawings:

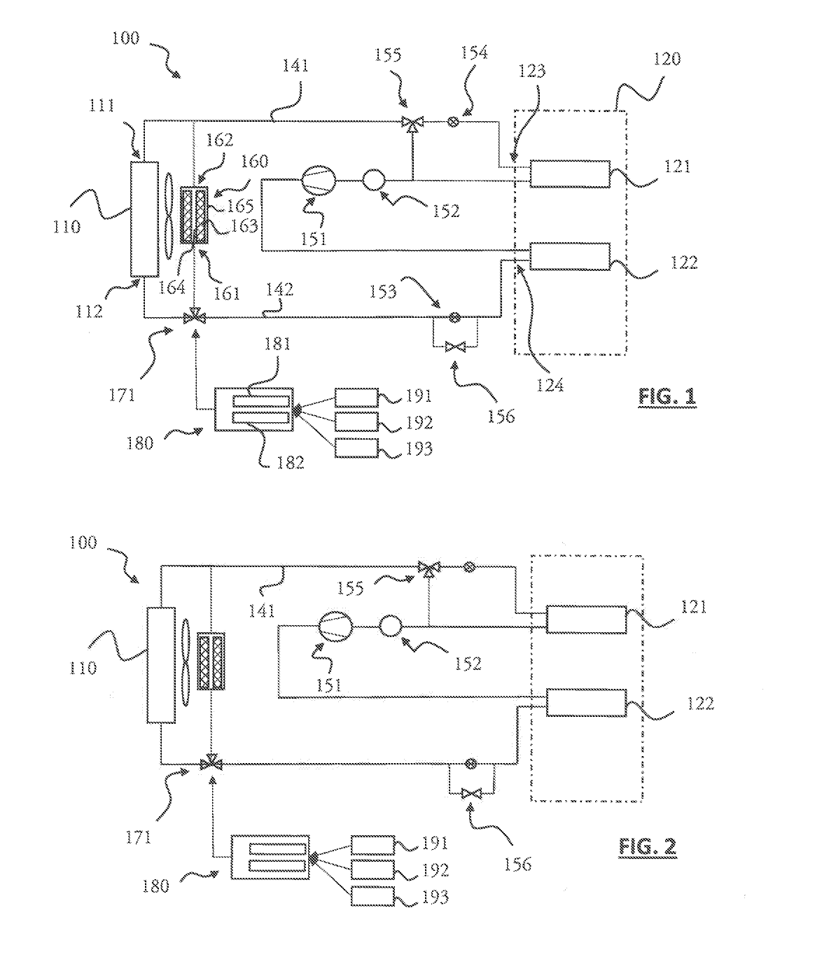

FIG. 1 is a schematic view of a coolant circulation loop according to a first embodiment, in a heat pump mode, the coolant being oriented to pass through the front-end air heater;

FIG. 2 is a schematic view of a coolant circulation loop according to another embodiment, in an air-conditioning mode, the coolant here being oriented to pass through the front-end air heater;

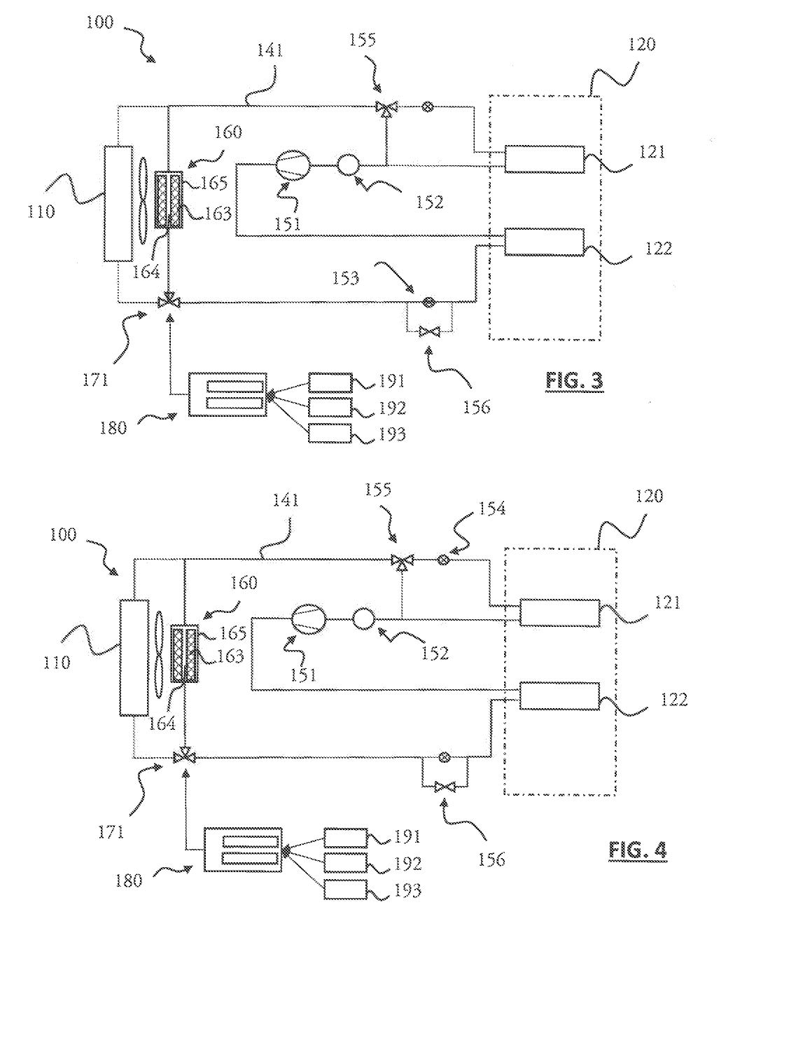

FIG. 3 is a schematic view of a coolant circulation loop, in a heat pump mode, to FIG. 1, the coolant here being oriented to pass through the thermal storage module;

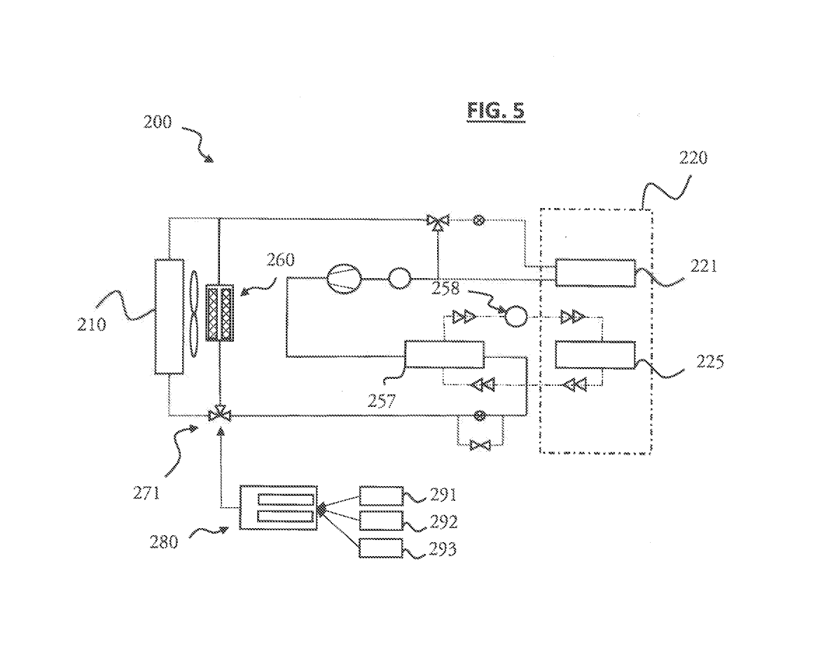

FIG. 4 is a schematic view of a. coolant circulation loop, in an air-conditioning mode, similar to FIG. 2, the coolant here being oriented to pass through the thermal storage module; and

FIG. 5 is a schematic view of a coolant circulation loop according to a second embodiment, in a heat pump mode, the coolant here being oriented to pass through the thermal storage module.

FIG. 1 illustrates a first embodiment of a circulation loop 100 according to the invention, comprising, in this example, a front-end air heater 110 intended to be present outside the interior of a vehicle, and particularly at the front face of the vehicle, under the front hood thereof, and a heat-exchange device 120 which can be arranged in proximity to the interior and comprising at least one evaporator 121. The front-end air heater 110 can in particular be arranged upstream of the engine compartment and it can in particular be an evaporator-condenser.

In the example illustrated, the heat-exchange device 120 takes the form of an HVAC unit comprising at least, in addition to the evaporator 121, an internal condenser 122. The heat-exchange device is a generator of air flows at regulated temperature, which takes in air, heats it up or cools it down, then sends it into the interior of the vehicle. More specifically, the air taken in is pulsed through the evaporator or the internal condenser, before being sent into the interior. The air taken in is either air that all originates from outside, or recycled air using at least a part of the air from the interior.

The heat-exchange means are preferably of air/fluid type, it being understood that the form of the exchanger could be modified without departing from the context of the invention.

A first duct 141 links an outlet 111 of the front-end air heater to an inlet 123 of the heat-exchange device. A second duet 142 links an outlet 124 of the heat-exchange device to an inlet 112 of the air heater, so as to form a loop in which a coolant circulates. The ducts can denote any type of line commonly used in the heating loops for a vehicle. As an example, a duct can denote a line produced from polymers, metal or alloys, capable of containing the coolant.

The coolant is made to assume several distinct phases—liquid or vapor—and several distinct pressure states as it. circulates in the loop according to the heat-exchange means that it has to supply. The loop can comprise in particular:
a compressor 151, in which the coolant, in vapor form, enters at low pressure to re-emerge at high pressure,
an accumulator 152 configured to separate the phases of the coolant and allow the latter to leave only in vapor form, and in particular arranged upstream of the compressor 151, and
a first expansion valve 153 and a second expansion valve 154 from where the coolant is made to leave at low pressure, in the form of liquid and of vapor.

The circulation loop further comprises a distribution element 155 configured to, depending whether a heat pump mode or an air-conditioning mode is targeted, orient the coolant toward the heat-exchange device 120 or directly to the compressor 151. The circulation loop also comprises a bypass 156, arranged in parallel to the first expansion valve 153, in order to be able to choose the state in which the coolant is brought to the front-end air heater 110, particularly so as to avoid the expansion in the expansion valve 153.

The circulation loop comprises, according to the invention, a thermal energy storage module 160, making it possible to exchange thermal energy with the coolant. For that, the storage module comprises an inlet 161 linked to the second duct 142 via a valve 171, of three-way valve type. An outlet 162 of the storage module is connected to the first duct 141 upstream of the compressor 151, and in particular upstream of the distribution element 155. Preferably, the outlet 162 of the storage module is linked as close as possible to the compressor 151 in order to limit the phenomena of heat losses when the fluid flows between the storage module 160 and the compressor 151. The storage module 160 is preferably configured to store between 200 and 1000 Wh at a temperature of the order of 15°0 C.

The thermal energy storage module 160 is configured to place the coolant in direct thermal contact with a determined quantity of material capable of changing phase 163, this “phase change material” or “PCM”, having the particular feature of being able to store the energy in the form of calories as it changes phase.

The thermal energy storage module 160 is formed in such a way that the coolant can be introduced into the casing via the inlet 161 and escape from the casing via the outlet 162. At least a part of the coolant can thus flow in the casing 165 and interact thermally with the phase change material 163. The phase change material put in place can for example take the form of tubes, microbeads or granules, along which the coolant can flow in passing through the casing. Obviously, other configurations allowing a thermal interaction between the phase change material and the coolant flowing through the casing can be envisaged.

In this first embodiment that is illustrated, the electrical energy storage module 160 is formed along a duct 164, mounted as bypass of the front-end air heater 110 for the circulation of the coolant, and it comprises a casing 165 defining a chamber receiving the phase change material 163 and surrounding the fluid circulation duct 164 in such a way that an inner wall is common with this duct. In this way, the heat exchange between the coolant and the phase change material is particularly effective and rapid in time. However, according to another possible embodiment, the easing 165 could also be produced in such a way as to have a wall distinct from that of the duct, a part of the wall of the casing then being conformed to mold to the form of the outer wall of the duct 164, the contact of the walls of the casing and of the duct allowing the heat exchange between the coolant and the phase change material, nevertheless with lower performance levels than the embodiment with a common wall. Moreover, the form of the casing can be configured according to any form other than cylindrical, making it possible to conduct a coolant and to contain a phase change material. According to the invention, the phase change material 163 is chosen so as to exhibit, within the range of temperatures obtained within the air heater, a solid-liquid transition. When the phase change material, after having been heated or cooled depending on its initial temperature, reaches its phase change temperature, it stores up or restores energy in relation to its near environment. When the vehicle is recharging, and the coolant is directed through the circulation duct 164 to pass through the storage module 160, the successive passages of the coolant through the storage module, reheated in each loop because it is circulating in closed loop mode, participate in increasing the temperature until the phase change temperature is reached, whereupon, to switch from a solid to liquid state in the example described, the phase change material absorbs a determined quantity of heat, that is a function of its mass and of the latent heat characteristic specific to each material.

Conversely, and particularly in a starting phase, where the aim is to raise the temperature of the coolant to optimize the production of hot air blown into the interior, the temperature of the phase change material drops until the phase change temperature is reached, and therefore to switch from a liquid state to a solid state, the phase change material then being transformed by restoring the energy previously stored.

According to one chosen example, the phase change material can be chosen from one of these materials, or at least include one of these materials:
inorganic compounds such as an alloy of organic salts and water;
organic compounds such as paraffins and fatty acids;
eutectic compounds;
composed of plant origin.

It will be possible to incorporate the phase change material in the storage module equally in liquid form and in solid form, and, in particular in the latter case, in the form of a polymerized composite material, for example in sheet form.

The phase change temperature range of the phase change material can in particular be of the order of 10° C. to 40° C., and it is advantageous in the mode of application described here to provide a critical phase change temperature of the PCM equal to 15° C.

It will be understood that this critical phase change temperature can vary from one application to another without departing from the context of the invention, and that the value of 15° C. is given here purely by way of example. It should be noted that the phase change material can also be characterized by the rate of absorption and of restoration of the energy, particularly for choosing a material capable of offering a great responsiveness to the temperature variations of the coolant, which can be made to vary frequently according to the thermal management needs of the vehicle.

There now follows a description of the useful application of a thermal storage module according to the invention, that is to say arranged in the circulation loop here in parallel with the front-end air heater,

The heating, ventilation and/or air-conditioning installation comprising this loop can in particular operate in a heat pump mode, with passage of the coolant in the front-end air heater (FIG. 1) or else passage of the coolant in the thermal storage module (FIG. 2), in an air-conditioning mode (FIG. 2), or even in a thermal storage module recharging mode (FIG. 4). In each of the figures, the ducts of the loop in which the coolant circulates according to the chosen mode have been illustrated by solid lines.

In each pump mode, a reheating of the air blown into the interior is sought. To this end, the distribution module 155 is controlled, in particular according to a command from the user, to be in a position blocking the passage of fluid to the evaporator of the heat-exchange device 120 and directing it directly to the accumulator 152 and the compressor 151. The coolant is brought to high pressure to be directed through the internal condenser 122 of the heat-exchange device. The result thereof is a transfer of heat with the air pulsed through the condenser, the mixing flap being displaced into a suitable position. The reheated. pulsed air penetrates into the interior and the cooled coolant continues its circulation through the loop by passing through the first expansion valve 153. The coolant, now at low pressure, flows along the second duct 142 until it encounters the valve 171. The valve is controlled to orient the fluid to the front-end air heater 110 (FIG. 1) or to the storage module 160 (FIG. 2). In the example illustrated, the valve is a 3-way valve, and it is understood that, without departing from the context of the invention, the same control could be produced with two 2-way valves for example. The conditions for controlling the valve can be a function of the temperature of the outside air, and/or of the temperature of the coolant in the second duct 142, and/or of the temperature of the phase change material 163 and/or a defined time period after the starting of the vehicle. These control conditions will in particular be detailed hereinbelow.

Generally, provision can be made for the valve 171 to be systematically controlled on startup on the position illustrated in FIG. 3, in which the coolant is oriented toward the thermal storage module, it being understood that, on starting the vehicle, the thermal storage module should normally be charged, that is to say include a phase change material ready to be cooled to transmit its energy to the coolant. It will be understood that it is possible to ensure, by an appropriate sensor placed downstream of the thermal storage module, that the fluid passing through the thermal storage module is modified and that the thermal storage module is thus correctly charged. Otherwise, the valve 171 would be controlled to revert to a standard operating mode, passing through the front-end air heater.

When, as illustrated in FIG. 3, the fluid passes through the duct 164 through the inner chamber filled with phase change material 163, the fluid is heated up and is then directed via the distribution module 155 once again to the accumulator and the compressor. The loops continue as is, with the valve 171 orienting the fluid to the storage module 160, until the phase change material, by dint of transfer of energy to the fluid, is brought to a temperature less than or equal to the temperature of the fluid, the storage module then being discharged. In this mode of operation, it is the energy of the phase change material which is used to heat up the fluid rather than the outside air. It is understood that it is possible to estimate the discharging time of the storage module in a normal mode of operation, for example as a function of the outside temperature, and that the valve 171 will be able to be automatically controlled in position orienting the fluid to the front-end air heater as soon as this estimated discharging time is reached. The valve 171 also Makes it possible to isolate the storage module 160 from the circulation loop for determined phases of operation, typically when the storage module is completely discharged (that is to say when the temperature of the phase change material becomes lower than the outside temperature, even lower than the outside temperature minus a given temperature difference, this difference being able to be set at −5° C. for example) or when the storage module is completely charged (that is to say when the temperature of the phase change material becomes higher than the melting point of the phase change material, even higher than the melting point plus a given temperature difference, in particular a difference of +5° C. for example).

This operation makes it possible, by the gradual destocking bf the energy of the phase change material, to reduce the consumption of the heat pump and/or to increase the heating power. The compressor consumes less energy for example because the coolant is hotter by virtue of the thermal storage means. The starting of the front-end air heater is delayed, and when the latter is activated, the power absorbed at the front face to increase the energy of the coolant is reduced, such that the risk of icing is limited/delayed through a reduction of the condensation on the walls of the front-end air heater.

Once the storage module is discharged, or estimated to be discharged, the position of the valve 171 is modified, and the fluid is oriented to the front-end air heater, such that there is a reversion to a conventional mode of operation, as illustrated in FIG. 1. The fluid then exchanges thermally with the ambient air passing through the front-end air heater, before being directed to the compressor.

The circulation loop can be configured to allow the switch to air-conditioning mode, particularly following a request from the user. In this case, the distribution element 155 directs the fluid through a second expansion valve 154 to lower the pressure and the temperature of the fluid before its passage through the evaporator 121 of the heat-exchange device 120, in which it participates in cooling the air pulsed subsequently into the interior. The coolant is then directed through the accumulator 152, the compressor 151, the internal condenser 122 in which it simply passes without heat exchange because the air mixing flap of the heat-exchange device 120 has blocked the intake of air into this condenser. The fluid then passes through the bypass 156 to avoid its expansion and remain at high pressure before being oriented through the front-end air heater 110, where it is cooled by the outside air. The result thereof is that this coolant that is cooled, then once again expanded by the second expansion valve 154 upstream of the evaporator 121, facilitates the cooling of the air passing through the evaporator in the next passage in the loop.

FIG. 4 illustrates a thermal storage module recharging mode, implemented in particular when the electric or hybrid vehicle is connected to mains to power the batteries. The valve 171 is controlled to orient the coolant through the thermal storage module. This recharging mode is performed with a loop configured in air-conditioning mode, that is to say with a coolant oriented by the distribution element 155 to the evaporator 121 of the heat-exchange device 120. Provision can be made to allow the air to circulate in the evaporator, or to block the air in a “hot gas” mode. The fluid circulating in the loop is set to high pressure by the compressor 151, then it is diverted by the bypass 156 to avoid the expansion of the first expansion valve 153, such that it penetrates into the thermal storage module 160 at high temperature, thus heating up the phase change material. This circulation mode is extended until the thermal storage module has stored a determined quantity of energy (for example, when the phase change material arrives at a temperature equal to ±5° C. relative to the outside temperature), or even the maximum quantity of energy that the storage module can store.

It can be noted that the thermal storage module, as arranged in parallel with the front-end air heater, is useful both in the heat pump mode illustrated in FIG. 3, for participating in the heating of the air of the interior in particular on starting the vehicle, and in the air-conditioning mode illustrated in FIG. 4, to be recharged. Whatever the position of the distribution element 155, the thermal storage module 160 is accessible.

Moreover, in the example illustrated, the actuation of the valve 171 can be controlled by a control unit 180 comprising a computer 181 making it possible to measure a determined time period and memory means 182 capable of memorizing a control program for the circulation loop described below, at least one temperature threshold value and/or at least one time reference value mentioned above.

The control unit 180 can be connected to a first thermal probe 191, intended to measure the temperature of the air outside the interior of the vehicle and it can be connected to a second thermal probe 192 intended to measure the temperature of the coolant circulating in the loop, particularly at the outlet of the air distribution element 155, it being understood that this second thermal probe 192, or an additional thermal probe, could be used to measure the temperature of the air inside the interior. The control unit 180 can also be connected to a third thermal probe 193 intended to measure the temperature of the phase change material in the storage module.

There now follows a description, referring to FIG. 5, of a second exemplary embodiment of a circulation loop 200 according to the invention. According to this new embodiment, the elements having the same functions as in the first embodiment are referenced with numbers having the same tens numeral and the same units numeral.

This second example differs from the preceding one in that the heat-exchange device 220 comprises an evaporator 221 aid a radiator 225, instead of the internal condenser described previously. The heating, ventilation and/or air-conditioning installation also comprises an additional coolant-water exchanger 257, of air-water condenser type, which forms, with the radiator 225, an additional loop in which glycol water circulates under the effect of a pump 258. in this case, the coolant is made to circulate in the condenser to exchange its heat with the glycol water which then transmits the heat to the air pulsed through the radiator 225 of the heat-exchange device 220. The thermal storage module 260 is, as previously, arranged in parallel with the front-end air heater 210 in order to divert all or part of the coolant, and it comprises, here, the same form of casing with a chamber receiving a phase change material.

FIG. 5 illustrates the energy storage mode, in which the coolant is made to circulate inside the storage module 260 to exchange heat therein without passing through the evaporator-condenser 210 in parallel with which the storage module 260 extends. It is understood that the other embodiments operate in a manner similar to what has been described previously.

In each of the embodiments of the circulation loop, it is possible to provide at least a step of measurement of the temperature of the ambient air and/or of the coolant circulating in the loop, followed by a step of comparison of this measured value with a temperature threshold value, and followed by a control step aiming to direct the coolant wholly or partly through the thermal storage module as a function of the result of the comparison step.

This method can in particular be implemented when the vehicle is switched on, or as soon as the compressor associated with the circulation loop is started up.

The temperature measurement can be done via the first thermal probe 191, 291 to determine a value of the temperature of the ambient air, present outside the interior of the vehicle, or by a second thermal probe 192, 292 to determine the temperature of the coolant, or by a third thermal probe 193, 293 to determine the temperature of the phase change material.

Depending on whether the value is below or above a temperature threshold memorized in the control unit 180, 280, it will be possible to control the valve 171, 271 in such a way that at least a part, preferably all, of the flow rate of the coolant originating from the heat-exchange device 120 or 220 passes through the storage module 160 or 260.

It will be understood on reading the above that the invention makes it possible, particularly when the electric or hybrid vehicle is in electrical charging mode, to store thermal energy in a storage module linked to a heat pump loop in a heating, ventilation and/or air-conditioning installation circulation of a coolant for a vehicle, in order to he able to reuse this stored energy, particularly on starting up the vehicle and when the temperature is very low, and for example lower than −10° C., in order, on the one hand, to avoid having the front-end air heater work with the risk of icing in such conditions, and, on the other hand, to reduce the power to be developed by the compressor and to extend the electrical range of the vehicle.

1. A coolant circulation loop for a motor vehicle comprising:
a heat-exchange device comprising at least an evaporator and a distribution element controlled to configure the loop according to at least a first mode in which the coolant does not pass through the evaporator and a second mode in which the coolant passes through the evaporator; and
a thermal energy storage module comprising a material capable of changing phase, the storage module being arranged on the passage of the fluid whether the loop is configured according to the first or the second mode.

2. The coolant circulation loop as claimed in claim 1, further comprising a front-end air heater, the thermal energy storage module being arranged in the circulation loop, in parallel with the front-end air heater.

3. The coolant circulation loop as claimed in claim 2, in which the thermal energy storage module is arranged in the circulation loop, in parallel with the front-end air heater via at least one valve to control the flow rate of coolant passing through the storage module.

4. The coolant circulation loop as claimed in claim 3, further comprising a control unit for modifying the position of the at least one valve such that at least a part of the coolant exchanges thermal energy with the storage module.

5. The coolant circulation loop as claimed in claim 3, in which the control unit modifies the position of the at least one valve such that the front-end air heater is fluidically isolated from the storage module.

6. The coolant circulation loop as claimed in claim 4, in which. the control unit is connected to a first thermal probe that measures the temperature of the air outside the interior of the vehicle.

7. The coolant circulation loop as claimed in claim 4, in which the control unit is connected to a second thermal probe that measures the temperature of the air inside the interior of the vehicle and/or the temperature of the coolant in a determined zone of the circulation loop.

8. The coolant circulation loop as claimed in claim 4, in which the control unit is connected to a third thermal probe measures the temperature of the phase change material in the storage module.

9. The coolant circulation loop as claimed in claim 1, in which the thermal energy storage module comprises a casing produced in a heat-conducting material, the casing being configured to:
contain the material capable of changing phase,
comprise an inlet and an outlet via which, respectively, the coolant is introduced into the casing and escapes from the casing, such that at least a part of the coolant flowing in the casing interacts thermally with the phase change material.

10. The coolant circulation loop as claimed in claim 9, in which a duct links the inlet and the outlet of the casing, the duct and the casing sharing at least one common wall such the heat of the coolant, respectively of the material capable of changing phase, is transferred via this wall to the material capable of changing phase, respectively to the coolant.

11. The coolant circulation loop as claimed in claim 1, in which the material capable of changing phase has a melting point lying between 10° and 40° C.

12. The coolant circulation loop as claimed in claim 1, in which the heat-exchange device further comprises an internal condenser.

13. The coolant circulation loop as claimed in claim 2, in which the heat-exchange device further comprises a radiator, and the radiator being coupled by an additional circuit to an additional coolant-water exchanger.

14. A vehicle comprising a coolant circulation loop as claimed in claim 1.

15. A method for controlling the circulation of a coolant in a loop as claimed in claim 1, comprising at least:
measuring the temperature of the ambient air and/or of the coolant circulating in the loop and/or of the phase change material;
comparison of this measured value with a temperature threshold value; and
directing the coolant wholly or partly through the thermal storage module as a function of the result of the comparison step.
